(19) United States
(12) Patent Application Publication
(10) Pub. No.: US 2016/0253305 A1
(43) Pub. Date: Sep. 1, 2016

(54) Filling Forms with a Smartphone

(71) Applicants: Calvin Wiese, Altamonte Springs, FL (US); Caleb Wiese, New York, NY (US)

(72) Inventors: Calvin Wiese, Altamonte Springs, FL (US); Caleb Wiese, New York, NY (US)

(21) Appl. No.: 15/053,751

(22) Filed: Feb. 25, 2016

Related U.S. Application Data
(60) Provisional application No. 62/121,865, filed on Feb. 27, 2015.

(51) Int. Cl. G06F 17/24; G06N 99/00; G06K 9/00

(52) U.S. Cl. CPC G06F 17/243; G06K 9/00449; G06N 99/005

(57) ABSTRACT

Form Filler App is a method for filling out forms using smartphone technology and image processing. It encompasses creating an image of the form with the smartphone's camera, then using image analysis to identify the input fields of the form. It will then map the fields to corresponding fields in a data repository then, using the data in the repository, digitally fill-in the form and deliver the completed form by fax, email or direct download.

A process that combines machine intelligence with human intelligence performs the task of identifying fields and mapping them to the data repository. The degree to which machine intelligence and human intelligence contribute may vary from zero to one hundred percent. In general, it is preferred to maximize the degree of machine intelligence and minimize the degree of human intelligence required. The identification and mapping function may be performed server-side by transmitting the digital image to a dedicated processor. The human intelligence processing may be performed internationally where labor costs are lower. A single form image can be divided into multiple sections so that multiple humans can process in parallel in order to minimize the turnaround time of individual forms.

The data repository stores the values of fields that are to be written onto the forms. The data in the repository needed to fill a form may be outdated or null, so a form that has been completed as the repository allows will be sent to the user with the values displayed on the form and the fields highlighted. The user may select any field for editing or updating. When selected for editing, a field editing control pops up configured to the parameters defined for the selected field. After the user has updated the form, they will be able to confirm delivery. The data that has been added or modified will then be saved to the data repository in the appropriate field, after passing a permission prompt from the user.

The data repository may support a wide variety of forms. In such cases, most forms will map to a subset of the data repository fields. In some cases, there may be fields on the forms without corresponding fields in the data repository. In such cases, the data repository may be easily extended to add the missing fields.

To ensure user security, encryption and decryption of personal data will be done on the user's device. When the user inputs data, it will be encrypted via secure cryptographic schemes before it is transmitted to the data repository where it will be stored as encoded information. Additionally, after the image processing has identified input fields and mapped them to fields in the repository, the encrypted data and a marked image of the form will be sent to the user's device. It is here that the data will be decoded and the information digitally written onto the form. Secure methods will be explored to deliver the completed form from the user's device to a fax machine or email address. The distance from the user that unencrypted data goes will be minimized.

Consumers are asked to fill out forms in a myriad of circumstances. Patients frequently fill out forms when they access healthcare. Schools and governments also require many forms to be filled. For those seeking employment a significant portion of their time is spent filling out repetitive application forms. In many cases, required data on a form is requested many times which results in tedium and frustration for the consumer.

There exists a great opportunity to assist consumers in filling out forms. An app on a smartphone that fills out forms using a data repository would be very attractive. The camera on a smartphone can be used to create a digital image of the form. The fields on the form can be mapped to corresponding fields in a data repository. Using this map, the data in the repository can be electronically written on the digital form. The completed form can be faxed, emailed to the point of service or downloaded directly to the device.

It's not apparent that this kind of functionality has been developed in the past. There are several types of document recognition that can extract data written in predetermined form fields. These types of applications seek to associate the extracted data to data fields. Our goal is to use image analysis to identify where the fields are located on the form and to determine the corresponding field in the data repository, and then to use this correspondence to input data onto the form. The image analysis can be done by both man-power and machine intelligence. In the past, images of forms were matched to preexisting templates and then data was entered into a data repository, we are extracting and identifying the structure of the form, without knowing the structure a priori, identifying its fields and then writing data from the repository onto the form.

A possibly similar application is an invoice reader. Invoice reading applications are typically capable of processing a wide variety of disparate invoice forms without specific training for each type of invoice form. They are capable of identifying key words to signify the types of data typically described on invoice forms. They can associate extracted data to these key words. Our tool is not a data extractor, but a data input device.

The domain of document recognition is commonly focused on acquiring data provided by others. This application differs from other document recognition applications in that it is doing the opposite; its focus is on providing data to others.

This application became feasible with the emergence of smartphones and other personal digital devices that combine portable capabilities for digital imaging, storage and internet access, and sufficient processing power that can be accessed to quickly perform the necessary computing and communication functions. Smartphones and other personal digital devices place these combined capabilities within the intimate reach of their holders at all times and at all places. As such, this power can be deployed at any time and at any place to perform these form-filling tasks whenever they are encountered.

We claim:

1. A method for filling out forms comprising using a smartphone camera to acquire a digital image of the form, using the digital image to map the fields of the form to a data repository, filling the fields of the form from the data repository, filling the fields of the form for which the data repository lacks data using user input, and transmitting the filled out form to a destination.

2. The method of claim 1 where the fields of the form are mapped to a data repository using human intelligence.

3. The method of claim 1 where the fields of the form are mapped to a data repository using machine intelligence.

4. The method of claim 1 where the fields of the form are mapped to a data repository using human intelligence combined with machine intelligence.

5. The method of claim 1 where the filled out form is transmitted to a destination by fax.

6. The method of claim 1 where the filled out form is transmitted to a destination by email.
